(19) United States
(12) Patent Application Publication
(10) Pub. No.: US 2025/0208600 A1
(43) Pub. Date: Jun. 26, 2025

(54) CONTRACT MANUFACTURING SUPPORT DEVICE AND CONTRACT MANUFACTURING SUPPORT PROGRAM

(71) Applicant: Manabe Zoki Co., Ltd., Ehime (JP)

(72) Inventor: Masayuki MANABE, Ehime (JP)

(21) Appl. No.: 18/294,131

(22) PCT Filed: Jun. 3, 2022
(86) PCT No.: PCT/JP2022/022668

§ 371 Date: Jan. 2, 2025

(30) Foreign Application Priority Data
Aug. 3, 2021 (JP) 2021-127559

(51) Int. Cl. G05B 19/4069; G05B 19/42

(52) U.S. Cl. CPC G05B 19/4069; G05B 19/4202

(57) ABSTRACT

In a contract manufacturing support device, a control unit acquires three-dimensional drawing data and a processing desired condition of a manufacturing outsourced product from a terminal of a manufacturer, simulates a processing process of the manufacturing outsourced product in a three-dimensional space on the basis of the three-dimensional drawing data, and three-dimensional device data and processable conditions acquired in advance from terminals of a plurality of processors, specifies an automated device capable of executing the processing process satisfying the processing desired condition among the automated devices owned by the processors, outputs a specification result to the terminal of the manufacturer, and outputs, in a case of acquiring an order instruction from the terminal of the manufacturer, a processing instruction of the manufacturing outsourced product and a teaching program for operating the automated device to a terminal of a processor that owns the specified automated device.

### FIELD

The present invention relates to a contract manufacturing support device and a contract manufacturing support program.

### BACKGROUND

Patent Literature 1 discloses a technique of selecting a processor capable of processing a part on the basis of an order request for the part which request is received from a terminal of a manufacturing entruster, and giving an order instruction to the selected processor.

### CITATION LIST

### Patent Literature

Patent Literature 1: Japanese Patent No. 6462945

### SUMMARY

### Technical Problem

In order to operate an automated device (such as a welding robot) that processes a part, a dedicated teaching program is required. For example, an operator called a teaching man controls an operation of the automated device of when actual work is performed, whereby this teaching program is created.

However, shortage of the teaching man is currently a major problem. In addition, although it is possible to outsource teaching to the automated device, there is a problem that a cost is high.

Here, in the technique disclosed in Patent Literature 1, a processor capable of performing teaching of an automated device by themself or a processor not using the automated device is selected. Thus, even a processor that owns an automated device capable of processing a part is not selected as an order destination of the part in a case where teaching cannot be performed. Even in a case where productivity is higher when the automated device is used, the selection as the order destination is not performed. Thus, processing is performed by a method with lower productivity.

The present invention has been made in view of the above, and an object thereof is to provide a contract manufacturing support device and a contract manufacturing support program capable of improving an operation rate of an automated device owned by a processor and selecting a processing method with higher productivity.

### Solution to Problem

To solve the problem and achieve the object, a contract manufacturing support device according to the present invention includes a control unit including hardware, wherein the control unit acquires three-dimensional drawing data and a processing desired condition of a manufacturing outsourced product from a terminal of a manufacturer that is an entruster of the manufacturing outsourced product, simulates, on a basis of the three-dimensional drawing data, and three-dimensional device data and a processable condition of an automated device owned by each of a plurality of processors which device data and condition are acquired in advance from terminals of the plurality of processors that can process the manufacturing outsourced product, a processing process of the manufacturing outsourced product in a three-dimensional space for each of the automated devices, specifies an automated device capable of performing the processing process satisfying the processing desired condition among the automated devices owned by the processors, and outputs a specification result to the terminal of the manufacturer, and outputs, in a case where an order instruction is acquired from the terminal of the manufacturer, a processing instruction of the manufacturing outsourced product and a teaching program for operating the automated device to a terminal of a processor that owns the specified automated device.

Moreover, in the contract manufacturing support device according to the present invention, when simulating the processing process of the manufacturing outsourced product, the control unit identifies a range to be processed by the automated device and a range to be processed manually on a basis of the three-dimensional drawing data, and then simulates the processing process of the manufacturing outsourced product, and when the teaching program is output to the terminal of the processor, the teaching program is output only for the range to be processed by the automated device.

Moreover, in the contract manufacturing support device according to the present invention, the control unit acquires a modified teaching program from the terminal of the processor in a case where the teaching program is modified by the processor in an actual processing process of the manufacturing outsourced product, and modifies an algorithm of an original teaching program created in advance on a basis of the acquired modified teaching program.

Moreover, in the contract manufacturing support device according to the present invention, the control unit acquires information related to operation rates of the automated devices from the terminals of the plurality of processors, and performs simulation of an automated device having the operation rate less than a predetermined value when simulating the processing process of the manufacturing outsourced product.

Moreover, in the contract manufacturing support device according to the present invention, the control unit acquires information related to operation rates of the automated devices from the terminals of the plurality of the processors, combines the plurality of automated devices and simulates the processing process of the manufacturing outsourced product in a case where it is determined that the processing process satisfying the desired processing condition cannot be performed with only one automated device in the simulation of the processing process of the manufacturing outsourced product, and specifies a plurality of automated devices capable of performing the processing process satisfying the processing desired condition among the automated devices owned by the processors, and outputs a specification result to the terminal of the manufacturer.

Moreover, in the contract manufacturing support device according to the present invention, the control unit further acquires information related to a desired delivery place from the terminal of the manufacturer, and specifies, from among the automated devices owned by the processors, an automated device that can perform the processing process satisfying the processing desired condition and that is owned by a processor closest to the desired delivery place or is arranged closest to the desired delivery place, and outputs a specification result to the terminal of the manufacturer.

Moreover, in the contract manufacturing support device according to the present invention, the processing desired condition includes at least one of a desired delivery date, a desired man-hour, or a desired cost.

Moreover, in the contract manufacturing support device according to the present invention, the specification result includes an estimated price of the manufacturing outsourced product which estimated price is calculated on a basis of a processing unit price of the manufacturing outsourced product which processing unit price is set for each of the processors.

Moreover, in the contract manufacturing support device according to the present invention, the processing unit price of the manufacturing outsourced product includes a processing unit price based on processing by the automated device and a processing unit price based on manual processing.

Moreover, to solve the problem and achieve the object, a contract manufacturing support program according to the present invention is the program causing a control unit including hardware to: acquire three-dimensional drawing data and a processing desired condition of a manufacturing outsourced product from a terminal of a manufacturer that is an entruster of the manufacturing outsourced product; simulate, on a basis of the three-dimensional drawing data, and three-dimensional device data and a processable condition of an automated device owned by each of a plurality of processors which device data and condition are acquired in advance from terminals of the plurality of processors that can process the manufacturing outsourced product, a processing process of the manufacturing outsourced product in a three-dimensional space for each of the automated devices; specify an automated device capable of performing the processing process satisfying the processing desired condition among the automated devices owned by the processors, and output a specification result to the terminal of the manufacturer; and output, in a case where an order instruction is acquired from the terminal of the manufacturer, a processing instruction of the manufacturing outsourced product and a teaching program for operating the automated device to a terminal of a processor that owns the specified automated device.

### Advantageous Effects of Invention

According to the contract manufacturing support device and the contract manufacturing support program according to the present invention, it is possible to improve the operation rate of the automated device owned by the processor, and it is possible to select a processing method with higher productivity.

### BRIEF DESCRIPTION OF DRAWINGS

FIG. 1 is a view illustrating an overall configuration of a contract manufacturing support system including a contract manufacturing support device according to an embodiment of the present invention.

FIG. 2 is a block diagram illustrating a configuration of the contract manufacturing support device according to the embodiment of the present invention.

FIG. 3 is a flowchart illustrating a procedure of a contract manufacturing support method executed by the contract manufacturing support device according to the embodiment of the present invention.

### DESCRIPTION OF EMBODIMENTS

A contract manufacturing support device and a contract manufacturing support program according to an embodiment of the present invention will be described with reference to the drawings. Note that the present invention is not limited to the following embodiments, and components in the following embodiments include what can be easily replaced by those skilled in the art or what is substantially the same.

### (Contract Manufacturing Support System)

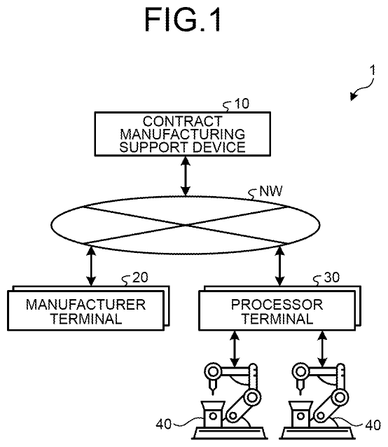

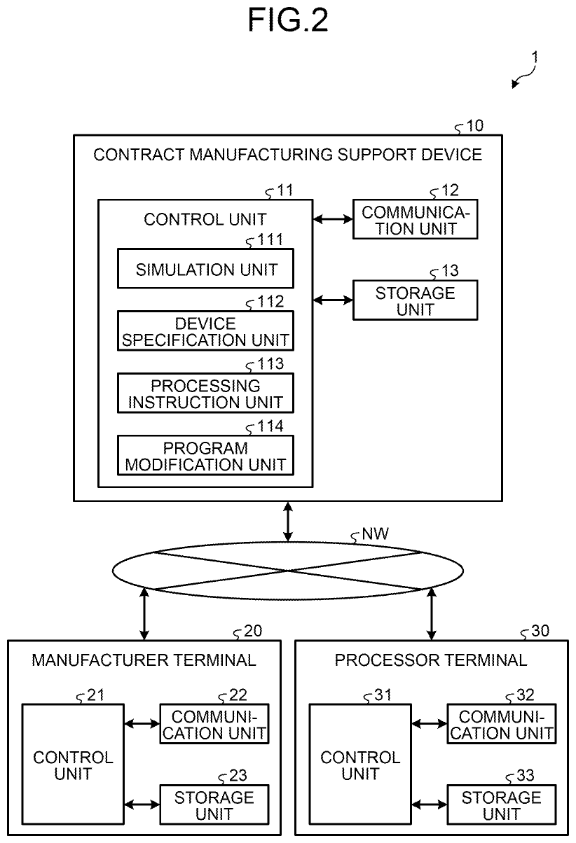

A contract manufacturing support system including a contract manufacturing support device according to the embodiment will be described with reference to FIG. 1 and FIG. 2. As illustrated in FIG. 1, a contract manufacturing support system 1 includes a contract manufacturing support device 10, a manufacturer terminal 20, and a processor terminal 30.

Each of the contract manufacturing support device 10, the manufacturer terminal 20, and the processor terminal 30 has a communication function, and is configured to be able to communicate with each other through a network NW. The network NW includes, for example, an Internet line network, a mobile phone line network, and the like.

### (Contract Manufacturing Support Device)

The contract manufacturing support device 10 is to support contract manufacturing of a manufacturing outsourced product which contract manufacturing is performed between a manufacturer that is an entruster of the manufacturing outsourced product and a processor that is a trustee of the manufacturing outsourced product. The contract manufacturing support device 10 is owned by a contract manufacturing support company (intermediary), and is realized by, for example, a general-purpose computer such as a workstation or a personal computer.

Here, examples of the “manufacturing outsourced product” include various products that can be targets of the contract manufacturing, such as a welded product, industrial part, and food (processed food). In the present embodiment, the description will be made on the assumption that the manufacturing outsourced product is a welded product.

As illustrated in FIG. 2, the contract manufacturing support device 10 includes a control unit 11, a communication unit 12, and a storage unit 13. Specifically, the control unit 11 includes a processor including a central processing unit (CPU), a digital signal processor (DSP), a field-programmable gate array (FPGA), a graphics processing unit (GPU), and the like, and a memory (main storage unit) including a random access memory (RAM), a read only memory (ROM), and the like.

The control unit 11 loads the program stored in the storage unit 13 into a work area of the main storage unit and executes the program, and controls each configuration unit or the like through execution of the program, whereby a function matching a predetermined purpose is realized. The control unit 11 functions as a simulation unit 111, a device specification unit 112, a processing instruction unit 113, and a program modification unit 114 through execution of a program stored in the storage unit 13.

The simulation unit 111 simulates a processing process (or manufacturing process) of the manufacturing outsourced product on the basis of information acquired from the manufacturer terminal 20 and the processor terminal 30. Hereinafter, details of processing in the simulation unit 111 will be described.

First, the simulation unit 111 acquires three-dimensional device data of an automated device 40 owned by each processor, a processable condition of the automated device 40, and information related to a processing unit price of the manufacturing outsourced product from processor terminals 30 of a plurality of processors capable of processing the manufacturing outsourced product. Note that the information related to the processing unit price of the manufacturing outsourced product may include only a processing unit price based on processing by the automated device 40, or may include a processing unit price based on manual processing in addition to the processing unit price based on the processing by the automated device 40.

The “three-dimensional device data” is information necessary for creating a teaching program for operating the automated device 40, and includes, for example, information such as a size, a movable range, and an operation speed of the automated device 40. In addition, the “processable condition” is information related to the manufacturing outsourced product that can be processed by the automated device 40, and includes, for example, a weight, a size, and the like of the manufacturing outsourced product.

For example, from the processor terminals 30 of the plurality of processors that have concluded a contract manufacturing support contract, the simulation unit 111 previously acquires the three-dimensional device data and the processable condition of each of the automated devices 40 owned by the processors. Timing at which the simulation unit 111 acquires the three-dimensional device data and the processable condition of the automated device 40 is not specifically limited, and the acquisition only needs to be performed at, for example, timing before a “simulation of a processing process” (described later). The simulation unit 111 stores the three-dimensional device data, the processable condition, and the information related to the processing unit price acquired from the processor terminals 30 into the storage unit 13 as necessary.

Note that the simulation unit 111 may further acquire information related to the operation rate of the automated device 40 from the processor terminal 30 of each of the processors. The “operation rate” is, for example, information indicating how much the automated device 40 owned by the processor is currently operating or how much the automated device will operate in the future. For example, in a case of a future operation rate of seven days from the current time point, “8 hours×7 days=56 hours” is the entire operation time. Then in a case where the operation rate is 80%, about 45 hours is the operation time of the automated device 40, and the remaining about 11 hours is the time during which processing can be accepted. The information related to the operation rate is acquired for each processor and stored into the storage unit 13 as necessary.

Furthermore, the information related to the operation rate may be, for example, information indicating operable time of the automated device 40 owned by the processor. In addition, the information related to the operation rate may be constantly transmitted (output) from the processor terminal 30 to the contract manufacturing support device 10, or may be sequentially transmitted at predetermined timing.

In addition, the simulation unit 111 may further acquire, from the processor terminal 30 of each of the processors, information related to a location of each of the processors and information related to a location of the automated device 40 owned by the processor.

Subsequently, the simulation unit 111 acquires the three-dimensional drawing data of the manufacturing outsourced product and a processing desired condition of the manufacturing outsourced product from the manufacturer terminal 20 of the manufacturer that is the entruster of the manufacturing outsourced product.

The “three-dimensional drawing data” is information necessary when the manufacturing outsourced product is processed (manufactured). The three-dimensional drawing data includes, for example, three-dimensional CAD data of the manufacturing outsourced product, information related to a processing range (such as a welding range), and information related to a range to be processed by the automated device 40 and a range to be processed manually. Note that the three-dimensional drawing data may include only the three-dimensional CAD data. In this case, for example, when the manufacturer transmits the three-dimensional drawing data to the contract manufacturing support device 10, the processing range is designated on a screen of the manufacturer terminal 20, and information related to the designated processing range is transmitted to the contract manufacturing support device 10 separately from the three-dimensional drawing data.

In addition, the “processing desired condition” is a condition of when the manufacturing outsourced product is processed, and includes, for example, at least one of a desired delivery date, a desired man-hour, or a desired cost. In other words, this processing desired condition indicates which one of the delivery date, the man-hour, and the cost is prioritized by the manufacturer when the manufacturing outsourced product is processed. The simulation unit 111 stores the three-dimensional drawing data of the manufacturing outsourced product acquired from the manufacturer terminal 20 and the processing desired condition into the storage unit 13 as necessary.

In addition, the simulation unit 111 may further acquire information related to a desired delivery place of the manufacturing outsourced product from the manufacturer terminal 20. The “desired delivery place” is information related to a country or a region where the manufacturing outsourced product is delivered. The simulation unit 111 stores the information related to the desired delivery place acquired from the manufacturer terminal 20 into the storage unit 13 as necessary.

Subsequently, the simulation unit 111 simulates the processing process of the manufacturing outsourced product in the three-dimensional space for each of the automated devices 40 on the basis of the three-dimensional data of the manufacturing outsourced product which data is acquired from the manufacturer terminal 20 and the three-dimensional device data and the processable conditions of the automated devices 40 which data and conditions are acquired in advance from the plurality of processor terminals 30. That is, the simulation unit 111 performs the simulation of the processing process of the manufacturing outsourced product for each of the automated devices 40 owned by each of the processors.

The simulation unit 111 simulates the processing process of the manufacturing outsourced product by using, for example, a known off-line teaching technique (such as an automatic teaching-type off-line teaching technique). In this case, the simulation unit 111 simulates the movement of the automated devices 40 in the three-dimensional space, and confirms postures of the automated devices 40, interference with an object to be processed, and the like.

Note that the simulation unit 111 may simulate the processing process in consideration of the operation rates of the automated devices 40 owned by the processors. In this case, as described above, the simulation unit 111 acquires the information related to the operation rate of the automated device 40 from each of the plurality of processor terminals 30.

Then, when simulating the processing process of the manufacturing outsourced product, the simulation unit 111 performs simulation on the automated device 40 the current or future operation rate of which is less than a predetermined value. Note that a specific operation rate of the automated device 40 to be simulated is not specifically limited. For example, the automated device 40 with the operation rate less than 80% may be a target, or the automated device 40 having the operation rate less than 100% may be a target.

As described above, by excluding the automated device 40 having the high operation rate and simulating the processing process of the manufacturing outsourced product, it is possible to avoid a situation in which the automated device 40 determined to be able to process the manufacturing outsourced product by the device specification unit 112 cannot actually operate. In addition, by excluding the automated device 40 with the high operation rate and simulating the processing process of the manufacturing outsourced product, it is possible to select the automated device in consideration of the operation rate in such a manner that the desired delivery date of the manufacturer is met.

In addition, the simulation unit 111 may simulate the processing process by the plurality of automated devices 40. In this case, as described above, the simulation unit 111 acquires the information related to the operation rate of the automated device 40 from each of the plurality of processor terminals 30.

Then, when simulating the processing process of the manufacturing outsourced product for each of the automated devices 40, the simulation unit 111 determines whether the processing process satisfying the processing desired condition can be performed with only one automated device 40. That is, the simulation unit 111 determines whether the desired delivery date, the desired man-hour, the desired cost, and the like requested by the manufacturer can be satisfied when the processing is performed by one automated device 40.

Then, in a case of determining that the processing process satisfying the processing desired condition cannot be performed with only one automated device 40, the simulation unit 111 combines a plurality of automated devices 40 and simulates the processing process of the manufacturing outsourced product. Note that the “plurality of automated devices 40” may be, for example, a plurality of automated devices 40 owned by one processor, or a plurality of automated devices 40 owned by a plurality of processors.

In addition, for example, a case where 80% of the entire processing process of the manufacturing outsourced product is processed by the automated device 40 and the remaining 20% is manually processed is also assumed. In this case, when simulating the processing process of the manufacturing outsourced product, the simulation unit 111 identifies a range to be processed by the automated device 40 and a range to be processed manually on the basis of the three-dimensional data of the manufacturing outsourced product acquired from the manufacturer terminal 20. Then, the processing process of the manufacturing outsourced product is simulated. As a result, even in a case where a part of the processing process of the manufacturing outsourced product is manually performed, it is possible to simulate the processing process by combining the processing by the automated device 40 and the manual processing.

On the basis of the simulation result in the simulation unit 111, the device specification unit 112 specifies, among the automated devices 40 owned by the processors, the automated device 40 capable of performing the processing process that satisfies the processing desired condition of the manufacturer. Then, the device specification unit 112 transmits the specification result to the manufacturer terminal 20. The specification result includes, for example, information such as a name of a processor that owns the specified automated device 40 and an estimated price of the manufacturing outsourced product. Note that the estimated price of the manufacturing outsourced product can be calculated on the basis of the processing unit price of the manufacturing outsourced product which unit price is set for each processor and is acquired from the processor terminal 30 in advance.

In addition, in a case where a part of the processing process of the manufacturing outsourced product is manually performed, the device specification unit 112 calculates the estimated price of the manufacturing outsourced product on the basis of the processing unit price based on the processing by the automated device 40 and the processing unit price based on the manual processing, and transmits the estimated price to the manufacturer terminal 20 as the above-described specification result. As a result, even in a case where a part of the processing process of the manufacturing outsourced product is manually performed, the estimated price can be calculated in consideration of the processing unit prices of the both.

In addition, in a case where simulation of the processing process by the plurality of automated devices 40 is performed by the simulation unit 111, the device specification unit 112 specifies the plurality of automated devices 40 capable of performing the processing process satisfying the processing desired condition of the manufacturer among the automated devices 40 owned by the processors. Then, the device specification unit 112 transmits the specification result to the manufacturer terminal 20. The specification result includes, for example, information such as a name of each of the processors that own the plurality of specified automated devices 40 and the estimated price of the manufacturing outsourced product.

As described above, since the processing process by the plurality of automated devices 40 is simulated, even in a case where the manufacturing outsourced product cannot be processed only with one automated device 40, it is possible to propose to process the manufacturing outsourced product by combination of the plurality of automated devices 40. In addition, by combining the plurality of automated devices 40 and performing the processing process, it is possible to improve the operation rates of the plurality of automated devices 40.

In addition, in a case where information related to a desired delivery place of the manufacturing outsourced product is further acquired from the manufacturer terminal 20, the device specification unit 112 specifies the automated device 40 as follows. That is, among the automated devices 40 owned by the processors, the automated device 40 that can perform the processing process satisfying the processing desired condition and that is owned by the processor closest to the desired delivery place or is arranged closest to the desired delivery place is specified. Note that with respect to the “automated device 40 owned by the processor closest to the desired delivery place”, a case where a location of the processor and a location of the automated device 40 are the same is assumed.

Then, the device specification unit 112 transmits the specification result to the manufacturer terminal 20. The specification result includes, for example, information such as a name of each of the processors that owns the specified automated device 40, an estimated price of the manufacturing outsourced product, a delivery place of the manufacturing outsourced product, and the like.

As described above, by specifying the automated device 40 in consideration of the desired delivery place requested by the manufacturer, it is possible to process the manufacturing outsourced product at a place close to the desired delivery place. Thus, it is possible to deliver the processed manufacturing outsourced product to the manufacturer at an early stage.

The processing instruction unit 113 instructs the processor terminal 30 to process the manufacturing outsourced product on the basis of the instruction from the manufacturer terminal 20. In a case of acquiring the order instruction of the manufacturing outsourced product from the manufacturer terminal 20, the processing instruction unit 113 transmits the processing instruction of the manufacturing outsourced product and the teaching program for operating the automated device 40 to the processor terminal 30 that owns the automated device 40 specified by the device specification unit 112.

In addition, in a case where a part of the processing process of the manufacturing outsourced product is manually performed, the processing instruction unit 113 transmits the teaching program only for a range to be processed by the automated device 40 when transmitting the teaching program to the processor terminal 30. As a result, even in a case where a part of the processing process of the manufacturing outsourced product is manually performed, the teaching program can be created only for the necessary processing range and provided to the processor.

Here, the teaching program transmitted from the processing instruction unit 113 to the processor terminal 30 is a program for operating the automated device 40 in the processing process of the manufacturing outsourced product outsourced by the manufacturer. As a method of creating the teaching program, there is a method of creating the teaching program by using off-line teaching.

In this case, for example, it is possible to use a method of designating all processing conditions of an object to be processed and reproducing the processing process in the three-dimensional space, a method of designating the processing conditions of the object to be processed to some extent and determining an operation of the automated device 40 on the basis thereof, and the like.

In addition, in a case where the teaching program is created by off-line teaching, machine learning can also be used. In this case, for example, a prediction model in which a welding range, a welding shape, a welding condition, a welding wire diameter, and the like are used as input data, and a teaching program including an operation of the automated device 40, welding construction conditions (such as arc voltage, welding current, and welding speed), and the like is output data is created in advance. Then, the teaching program of the automated device 40 is created by utilization of this prediction model. Note that as a method of machine learning, for example, various methods such as a neural network, a decision tree, a random forest, and support vector regression can be used.

Note that timing of creating the teaching program is not specifically limited. For example, in a case where the teaching program is created by the off-line teaching, the entire teaching program for each of the automated devices 40 is created at a stage of simulation in the simulation unit 111. Then, the teaching program of the automated device 40 specified by the device specification unit 112 may be transmitted to the processor terminal 30 of the processor that owns the automated device 40. Alternatively, the teaching program is not created at the stage of simulation in the simulation unit 111, and the teaching program of the automated device 40 is created at the stage at which the automated device 40 is specified by the device specification unit 112. Then, transmission to the processor terminal 30 of the processor that owns the automated device 40 may be performed.

In addition, in a case where machine learning is used in the off-line teaching, a teaching program for the automated device 40 is created at arbitrary timing between the simulation in the simulation unit 111 and the specification of the automated device 40 in the device specification unit 112. Then, transmission to the processor terminal 30 of the processor that owns the automated device 40 may be performed. Alternatively, the teaching program may be created in advance for each of the automated devices 40, and after specification of the automated device 40 by the device specification unit 112, the teaching program thereof may be transmitted to the processor terminal 30 of the processor that owns the automated device 40. Note that the teaching program created by the off-line teaching is stored in the storage unit 13 as necessary.

The program modification unit 114 modifies the teaching program. For example, in a case where the teaching program is modified by the processor in the actual processing process of the manufacturing outsourced product, the program modification unit 114 acquires the modified teaching program from the processor terminal 30 of the processor. Then, the program modification unit 114 modifies an algorithm of the original teaching program created in advance on the basis of the acquired corrected teaching program.

As described above, in a case where the teaching program used in the actual processing process is modified, an algorithm for creating the teaching program can be optimized by modification of the algorithm of the original teaching program according to the modification.

The communication unit 12 includes, for example, a local area network (LAN) interface board, a wireless communication circuit for wireless communication, and the like. The communication unit 12 is connected to a network NW such as the Internet that is a public communication network. Then, the communication unit 12 communicates with the manufacturer terminal 20 and the processor terminal 30 by being connected to the network NW.

The storage unit 13 includes recording media such as an erasable programmable ROM (EPROM), a hard disk drive (HDD), and a removable medium. Examples of the removable medium include a universal serial bus (USB) memory, and a disc recording medium such as a compact disc (CD), a digital versatile disc (DVD), or a Blu-ray (registered trademark) disc (BD). The storage unit 13 can store an operating system (OS), various programs, various tables, various databases, and the like.

For example, the storage unit 13 stores, as necessary, three-dimensional device data of the automated devices 40, the processable conditions of the automated devices 40, information related to the operation rates of the automated devices 40, information related to the processing unit price of the manufacturing outsourced product, and the like acquired from the processor terminals 30. The storage unit 13 also stores, as necessary, the three-dimensional drawing data of the manufacturing outsourced product, the processing desired condition of the manufacturing outsourced product, information related to the desired delivery place of the manufacturing outsourced product, and the like acquired from the manufacturer terminal 20. In addition, off-line teaching application software for realizing the function of the simulation unit 111, the previously-created teaching program of the automated device 40, and the like are also stored in the storage unit 13 as necessary.

### (Manufacturer Terminal)

The manufacturer terminal 20 is to exchange information with the contract manufacturing support device 10. The manufacturer terminal 20 is owned by a manufacturer, and is realized by, for example, a general-purpose computer such as a workstation or a personal computer.

As illustrated in FIG. 2, the manufacturer terminal 20 includes a control unit 21, a communication unit 22, and a storage unit 23. The control unit 21, the communication unit 22, and the storage unit 23 are similar in hardware to the control unit 11, the communication unit 12, and the storage unit 13. Note that although not illustrated in the drawing, an input unit such as a mouse or a keyboard and an output unit such as a display or a printer may be connected to the manufacturer terminal 20.

The control unit 21 transmits the three-dimensional drawing data of the manufacturing outsourced product, the processing desired condition of the manufacturing outsourced product, the information related to the desired delivery place of the manufacturing outsourced product, and the like to the contract manufacturing support device 10, for example, on the basis of operation by an operator that belongs to the manufacturer.

The storage unit 23 stores, as necessary, the three-dimensional drawing data of the manufacturing outsourced product, information such as the estimated price of the manufacturing outsourced product which information is acquired from the contract manufacturing support device 10.

### (Processor Terminal)

The processor terminal 30 exchanges information with the contract manufacturing support device 10. The processor terminal 30 is owned by the processor, and is realized by, for example, a general-purpose computer such as a workstation or a personal computer.

As illustrated in FIG. 2, the processor terminal 30 includes a control unit 31, a communication unit 32, and a storage unit 33. The control unit 31, the communication unit 32, and the storage unit 33 are similar in hardware to the control unit 11, the communication unit 12, and the storage unit 13. Note that although not illustrated in the drawing, an input unit such as a mouse or a keyboard and an output unit such as a display or a printer may be connected to the manufacturer terminal 20.

The control unit 31 transmits the three-dimensional device data of the automated device 40, the processable condition of the automated device 40, the information related to the operation rate of the automated device 40, the information related to the processing unit price of the manufacturing outsourced product, and the like to the contract manufacturing support device 10 on the basis of operation by an operator that belongs to the processor, for example. In addition, the control unit 31 transmits the teaching program of the automated device 40 which program is acquired from the contract manufacturing support device 10 to the automated device 40 and causes the automated device 40 to perform the processing process of the manufacturing outsourced product.

For example, the storage unit 33 stores, as necessary, the three-dimensional device data of the automated device 40, the processable condition of the automated device 40, information related to the operation rate of the automated device 40, information related to the processing unit price of the manufacturing outsourced product, and the like. The storage unit 33 also stores, as necessary, the teaching program and the like of the automated device 40 which program and the like are acquired from the contract manufacturing support device 10.

### (Contract Manufacturing Support Method)

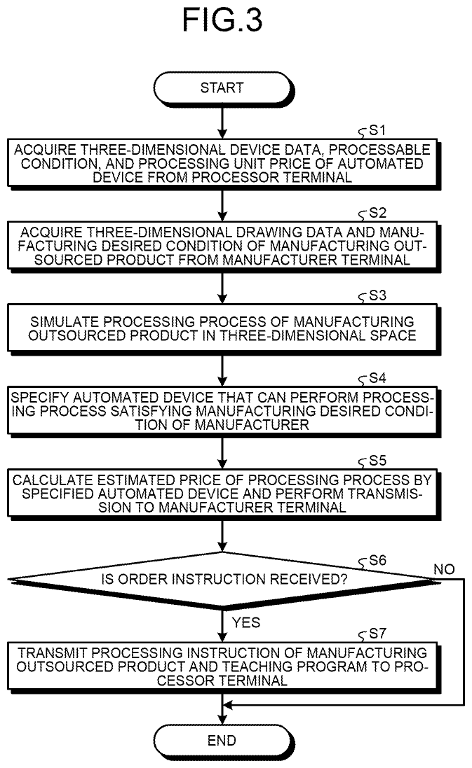

An example of a processing procedure of the contract manufacturing support method executed by the contract manufacturing support device 10 according to the embodiment will be described with reference to FIG. 3.

First, the simulation unit 111 acquires, from the processor terminals 30, the three-dimensional device data, the processable conditions, and the information related to the processing unit prices of the automated devices 40 (Step S1). Subsequently, the simulation unit 111 acquires the three-dimensional drawing data and a manufacturing desired condition of the manufacturing outsourced product from the manufacturer terminal 20 (Step S2).

Subsequently, the simulation unit 111 simulates the processing process of the manufacturing outsourced product in the three-dimensional space for each of the automated devices 40 on the basis of the three-dimensional data of the manufacturing outsourced product, the three-dimensional device data and the processable condition of the automated device 40 (Step S3).

Subsequently, on the basis of the simulation result of Step S3, the device specification unit 112 specifies the automated device 40 capable of performing the processing process satisfying the processing desired condition of the manufacturer among the automated devices 40 owned by the processors (Step S4). Subsequently, the device specification unit 112 calculates an estimated price of the processing process by the specified automated device 40, and transmits the estimated price to the manufacturer terminal 20 (Step S5).

Subsequently, the processing instruction unit 113 determines whether the order instruction for the manufacturing outsourced product is received from the manufacturer terminal 20 (Step S6). In a case where it is determined in Step S6 that the order instruction for the manufacturing outsourced product is received from the manufacturer terminal 20 (Yes in Step S6), the processing instruction unit 113 transmits the processing instruction for the manufacturing outsourced product and the teaching program to the processor terminal 30 (Step S7), and completes the present processing. In a case where it is determined in Step S6 that the order instruction for the manufacturing outsourced product is not received from the manufacturer terminal 20 (No in Step S6), the processing instruction unit 113 completes the present processing.

According to the contract manufacturing support device and the contract manufacturing support program according to the embodiment described above, the processing process of the manufacturing outsourced product is simulated for each of the automated devices 40 owned by the processors. Then, the automated device 40 capable of performing the processing process satisfying the processing desired condition of the manufacturer is specified and proposed to the manufacturer, whereby the operation rate of the automated devices 40 owned by the processors can be improved.

In addition, according to the contract manufacturing support device and the contract manufacturing support program according to the embodiment, the teaching program of the automated device 40 necessary for manufacturing the manufacturing outsourced product is provided to the processor. As a result, the operation rate of the automated device 40 owned by the processor can be improved. In addition, according to the contract manufacturing support device and the contract manufacturing support program according to the embodiment, by providing the teaching program created on the basis of the simulation result of the processing process of the manufacturing outsourced product to the processor, it is possible to reduce the man-hours of the processor.

In addition, according to the contract manufacturing support device and the contract manufacturing support program according to the embodiment, it is possible to mediate the outsourcing to the processor with the highest productivity for the manufacturer that performs the contract manufacturing, and it is possible to reduce the man-hours of the manufacturer in selection of the processor. In addition, according to the contract manufacturing support device and the contract manufacturing support program according to the embodiment, it is possible to select a processing method with higher productivity.

The contract manufacturing support device and the contract manufacturing support program according to the present invention have been specifically described above with reference to the embodiments and examples. However, the gist of the present invention is not limited to these descriptions, and should be broadly interpreted on the basis of descriptions in the claims. It goes without saying that various changes, modifications, and the like based on these descriptions are also included in the gist of the present invention.

### REFERENCE SIGNS LIST

1 CONTRACT MANUFACTURING SUPPORT SYSTEM
10 CONTRACT MANUFACTURING SUPPORT DEVICE
11 CONTROL UNIT
111 SIMULATION UNIT
112 DEVICE SPECIFICATION UNIT
113 PROCESSING INSTRUCTION UNIT
114 PROGRAM MODIFICATION UNIT
12 COMMUNICATION UNIT
13 STORAGE UNIT
20 MANUFACTURER TERMINAL
21 CONTROL UNIT
22 COMMUNICATION UNIT
23 STORAGE UNIT
30 PROCESSOR TERMINAL
31 CONTROL UNIT
32 COMMUNICATION UNIT
33 STORAGE UNIT
40 AUTOMATED DEVICE

1. A contract manufacturing support device comprising a control unit including hardware, wherein the control unit
acquires three-dimensional drawing data and a processing desired condition of a manufacturing outsourced product from a terminal of a manufacturer that is an entruster of the manufacturing outsourced product,
simulates, on a basis of the three-dimensional drawing data, and three-dimensional device data and a processable condition of an automated device owned by each of a plurality of processors which device data and condition are acquired in advance from terminals of the plurality of processors that can process the manufacturing outsourced product, a processing process of the manufacturing outsourced product in a three-dimensional space for each of the automated devices,
specifies an automated device capable of performing the processing process satisfying the processing desired condition among the automated devices owned by the processors, and outputs a specification result to the terminal of the manufacturer, and
outputs, in a case where an order instruction is acquired from the terminal of the manufacturer, a processing instruction of the manufacturing outsourced product and a teaching program for operating the automated device to a terminal of a processor that owns the specified automated device.

2. The contract manufacturing support device according to claim 1, wherein
when simulating the processing process of the manufacturing outsourced product, the control unit identifies a range to be processed by the automated device and a range to be processed manually on a basis of the three-dimensional drawing data, and then simulates the processing process of the manufacturing outsourced product, and
when the teaching program is output to the terminal of the processor, the teaching program is output only for the range to be processed by the automated device.

3. The contract manufacturing support device according to claim 1 or claim 2, wherein the control unit
acquires a modified teaching program from the terminal of the processor in a case where the teaching program is modified by the processor in an actual processing process of the manufacturing outsourced product, and
modifies an algorithm of an original teaching program created in advance on a basis of the acquired modified teaching program.

4. The contract manufacturing support device according to any one of claim 1 to claim 3, wherein the control unit
acquires information related to operation rates of the automated devices from the terminals of the plurality of processors, and
performs simulation of an automated device having the operation rate less than a predetermined value when simulating the processing process of the manufacturing outsourced product.

5. The contract manufacturing support device according to any one of claim 1 to claim 3, wherein the control unit
acquires information related to operation rates of the automated devices from the terminals of the plurality of the processors,
combines the plurality of automated devices and simulates the processing process of the manufacturing outsourced product in a case where it is determined that the processing process satisfying the desired processing condition cannot be performed with only one automated device in the simulation of the processing process of the manufacturing outsourced product, and
specifies a plurality of automated devices capable of performing the processing process satisfying the processing desired condition among the automated devices owned by the processors, and outputs a specification result to the terminal of the manufacturer.

6. The contract manufacturing support device according to any one of claim 1 to claim 3, wherein the control unit
further acquires information related to a desired delivery place from the terminal of the manufacturer, and
specifies, from among the automated devices owned by the processors, an automated device that can perform the processing process satisfying the processing desired condition and that is owned by a processor closest to the desired delivery place or is arranged closest to the desired delivery place, and outputs a specification result to the terminal of the manufacturer.

7. The contract manufacturing support device according to any one of claim 1 to claim 6, wherein
the processing desired condition includes at least one of a desired delivery date, a desired man-hour, or a desired cost.

8. The contract manufacturing support device according to any one of claim 1 to claim 7, wherein
the specification result includes an estimated price of the manufacturing outsourced product which estimated price is calculated on a basis of a processing unit price of the manufacturing outsourced product which processing unit price is set for each of the processors.

9. The contract manufacturing support device according to claim 8, wherein
the processing unit price of the manufacturing outsourced product includes a processing unit price based on processing by the automated device and a processing unit price based on manual processing.

10. A contract manufacturing support program causing a control unit including hardware to:
acquire three-dimensional drawing data and a processing desired condition of a manufacturing outsourced product from a terminal of a manufacturer that is an entruster of the manufacturing outsourced product;
simulate, on a basis of the three-dimensional drawing data, and three-dimensional device data and a processable condition of an automated device owned by each of a plurality of processors which device data and condition are acquired in advance from terminals of the plurality of processors that can process the manufacturing outsourced product, a processing process of the manufacturing outsourced product in a three-dimensional space for each of the automated devices;
specify an automated device capable of performing the processing process satisfying the processing desired condition among the automated devices owned by the processors, and output a specification result to the terminal of the manufacturer; and
output, in a case where an order instruction is acquired from the terminal of the manufacturer, a processing instruction of the manufacturing outsourced product and a teaching program for operating the automated device to a terminal of a processor that owns the specified automated device.
